(19) United States
(12) Patent Application Publication
(10) Pub. No.: US 2025/0025838 A1
(43) Pub. Date: Jan. 23, 2025

(54) HOLLOW FIBER MEMBRANE DISTILLATION MODULE AND PROCESS

(71) Applicant: KMX TECHNOLOGIES, INC, Wilmington, DE (US)

(72) Inventors: Seyed B SADR GHAYENI, Cote Saint Luc (CA); Martin Johannes HAUSCHILD, Perth (CA); Hubert FLEMING, Fenwick Island (DE)

(73) Assignee: KMX TECHNOLOGIES, INC, Wilmington, DE (US)

(21) Appl. No.: 18/714,680

(22) PCT Filed: Dec. 2, 2022
(86) PCT No.: PCT/US2022/051634

§ 371 Date: May 30, 2024

(30) Foreign Application Priority Data
Dec. 2, 2021 (US) 63285378
Apr. 7, 2022 (US) 63328501

(51) Int. Cl. B01D 63/02; B01D 61/36; B01D 69/02; C02F 1/44

(52) U.S. Cl. CPC B01D 63/033; B01D 61/364; B01D 63/023; B01D 69/02; C02F 1/447; B01D 2313/04; B01D 2313/21; B01D 2325/38

(57) ABSTRACT

A membrane distillation module comprises a hollow fiber membrane bundle in a housing. A plurality of hydrophobic hollow fiber membranes is secured at each end in membrane boots by chemical bonding of the fiber membrane to a potting compound. The membrane bundle is supported by supporting rods secured to flanges attached to the membrane boots. Fiber packing density is selected to optimize passage of vapor away from the permeate side of the hollow fiber membranes. A center core spanning the length of the membrane bundle serves to conduct feedwater entering the bottom of the module to a bundle top cap where the feedwater is evenly distributed into the hollow fiber membranes. The housing is configured to accommodate expansion of liquid water to the vapor phase during vacuum membrane distillation and to facilitate exit of water vapor from the module via an outlet connected to a vacuum pump.

### RELATED APPLICATIONS

This application claims priority of U.S. Provisional Application No. 63/285,378 filed Dec. 2, 2021 and U.S. Provisional Application No. 63/328,501 filed Apr. 7, 2022, the entire contents of which are incorporated herein by reference.

### TECHNICAL FIELD

The invention relates to devices and methods for water treatment. More particularly, the invention relates to a vacuum membrane distillation module, including a membrane bundle and a membrane housing, and a process for the separation of dissolved solids from water using the module.

### BACKGROUND

Clean water is needed for human consumption and other applications (e.g., industry). However, supplies of clean water are finite and severely limited in certain parts of the world. An ever-increasing human population creates a demand for potable water. Water containing impurities is treated or purified to produce clean water. For example, salt may be removed from seawater to produce potable water.

Membrane distillation processes are known in which the selectivity of the membrane is based on the retention of liquid water with concurrent permeability for water vapor. A temperature difference provided between the feed side and the permeate side of the membrane creates a partial water vapour pressure difference across the membrane which drives water vapor produced at the feed-side surface of the membrane to pass through the membrane wall towards the permeate side. In vacuum membrane distillation (VMD), by using a vacuum pump, water vapor that has passed through the membrane wall is transferred through permeate side into a condenser where it is condensed.

U.S. Patent Publication No. US2020/0109070 describes a membrane module for membrane distillation comprising a bundle of hydrophobic porous hollow fiber membranes with through holes, housed in a cylindrical container. A surface of the hollow fiber membranes comprises a coating of a water-repellant agent. Water to be treated is passed through the hollow fiber membrane interiors, and water vapor that has exited from the outer side is cooled and condensed and recovered as permeated water.

To obtain high-purity water by membrane distillation methods it is essential that the components of raw water passing through the membrane do not leak to the permeated water side. If the surface tension of water to be treated is reduced by organic components, it can cause wetting of the interiors of the pores of the porous membrane used for the membrane distillation and passage through the interior of the pores, thus causing leakage from the raw water side of the membrane through to the permeate side, a phenomenon known as “wetting”. Wetting prevents the function of membrane distillation from being achieved. For membrane modules where both ends of a hollow fiber membrane are anchored in a housing with an adhesive resin, wetting of the membrane tends to occur near the borders between adhesively anchored locations and non-adhesively anchored locations, and in locations close to the raw water inlet, where the temperature of the raw water is higher, and the amount of vapour generated is higher. U.S. Patent Publication No. US2022/0080358 describes a module in which the amount of hydrophobic polymer per membrane area adhering to the locations of the hollow fiber membrane prone to wetting is greater than at other locations.

U.S. Patent Publication No. US2022/0001331 describes a membrane distillation module comprising a substantially columnar membrane cartridge for membrane distillation in a housing. The cartridge includes affixation parts in which ends of hollow fiber hydrophobic porous membranes are affixed with an affixation resin. Support parts of the housing support the affixation parts via sealing members.

Existing systems for separating dissolved solids from water are complex and expensive to manufacture, operate and maintain, which can render them uneconomic to operate. There remains a continuing need for research into structures of membrane distillation modules that incorporate hydrophobic hollow fiber membranes, in order to increase the throughput of membrane distillation modules that incorporate the membranes while providing devices and systems which are robust, easy to maintain and give improved efficiency in operation.

### SUMMARY OF THE INVENTION

Following diligent and extensive research, the inventors came to realize that existing membrane module designs are inherently unsuitable for vacuum membrane distillation applications because, unlike other filtration processes, VMD is accompanied by a change of solvent phase from liquid to vapour as water crosses the membrane from feed side to permeate side. Existing designs fail to take account of the massive expansion that accompanies the transition from water in the liquid phase to water vapour. Traditional membrane module designs, such as flat sheet, plate and frame, or spiral wound, fail to allow space on the permeate side of the membrane for the increased volume of water vapour with the result that the module becomes choked, and flux is impeded.

As the water in the feed evaporates, it expands to occupy a much bigger volume. Expansion of water under vacuum is even greater. As the water in the feed changes from liquid to vapour, its volume increases by a factor of approximately 1000. This huge expansion must be accommodated. The inventors realized that prior designs failed to provide adequate space for permeate vapor from the membrane to move from the bundle, through the housing to the condenser, so the system becomes choked because the fibers are producing more permeate than the space can accommodate. The inventors have designed a system to accommodate the expanded vapor volume, to allow vapor to move through the system and permit the membrane distillation to occur with greater efficiency and enhanced throughput.

By extensive research and modelling, the inventors have developed a VMD module design that optimizes vapor space and can achieve substantially higher flux than previously available designs.

The invention provides a hollow fiber membrane distillation module (HFDM) comprising a hollow fiber membrane bundle and a housing for containing the membrane bundle, wherein:
the membrane bundle comprises a plurality of hydrophobic hollow fiber membranes having a first end and a second end, the first end and the second end being secured in a first membrane boot and a second membrane boot, respectively, by chemical bonding of the fiber membrane to a potting compound;
the membrane bundle is supported by a plurality of supporting rods;
each of the first membrane boot and the second membrane boot has an attached flange to which respective ends of the supporting rods are secured, thereby spacing the first membrane boot from the second membrane boot such that the hydrophobic hollow fiber membranes are disposed longitudinally therebetween;
the hydrophobic hollow fiber membranes are packed at a density selected to optimize passage of vapor away from a permeate side of the hydrophobic hollow fiber membranes towards the housing;
the membrane bundle is not enclosed in a porous or perforated sleeve;
a center core spans the length of the membrane bundle;
the housing comprises a tubular body and a bottom cap, is connected to a vapor header, and is configured to optimise throughput of permeate by accommodating expansion of liquid water to the vapor phase during vacuum membrane distillation and to facilitate exit of water vapor from the module via an outlet of the vapor header, said outlet connected to a vacuum pump.

The membrane bundle cooperates with the housing to define a feed water path on the feed side of the membranes between the feed water inlet and the concentrate outlet. Water vapor passes through the membranes to a vapor zone comprising a vapor header on the permeate/vapor side of the membranes and is drawn from the vapor header under vacuum.

The module of the invention can achieve flux of 10-60 l/m²/hour. This is a much higher permeate flux compared to earlier designs, which had a maximum flux of 4 l/m²/h.

Hollow fiber membranes suitable for use in the invention exhibit strong hydrophobicity, strong mechanical properties, sufficient porosity, and suitable pore size. The materials of hollow fibers can be any polymeric compound with the mentioned characteristics with strong hydrophobicity and resistance to higher temperature under vacuum such as polytetrafluoroethylene (PTFE), PS, PP, PVDF etc.

The hollow fiber membranes are secured at each end of the membrane bundle in a membrane boot containing a potting compound. The fiber membranes used (for example PTFE materials) are by nature hydrophobic and cannot stick to normal epoxy materials that by nature have hydrophilic groups. Therefore, traditionally, hydrophobic compressible materials have been used to hold the fibers together in the membrane boots at the two ends of the bundle. The role of these hydrophobic compressible materials is to hold the fibers in place and to provide a seal which prevents the leakage of liquid into the vapor side of the module. In such case, packed fibers are contained by compression, i.e., the fibers are held by physical forces. The inventors have found that physically retaining the fibers in a potting compound is not sufficiently robust for the rigours of vacuum membrane distillation, especially at lower fiber densities. Under normal operation when hydraulic pressure and vacuum is applied to the membrane module the hydrophobic compressible materials can be easily displaced and therefore the membrane bundle can lose its integrity causing severe leakages from the dislocated positions. This causes the bundle to fail. Physical bonding is not suitable for membrane distillation applications when the fibers are hydrophobic by nature. However, if membrane fibers are secured via a chemical bonding a durable and robust bond is produced which will keep the integrity of the potting materials and fibers and so will prevent the main source of leakage which was experienced with physical bonding. Chemical bonding of the fiber membranes makes a significant contribution to vacuum membrane distillation and brings the following benefits: a) strong integrity between fibers and potting materials b) produces bundles with negligible liquid leakage, c) makes it possible to produce bundles with lower packing densities which in turn makes it possible to produce much higher membrane flux of up to 50 l/m²/h and higher.

The supporting rods connected to the flanges on each of the first and second membrane boots (which may also be referred to herein as top and bottom membrane boots) provide structural rigidity to the membrane bundle. Employing supporting rods, together with optimizing packing density and accommodating vapor space within the module housing, allows unimpeded egress of water vapour outwardly from the membrane bundle, enabling enhanced flux compared to designs where the membrane bundle is encased in a porous or perforated sleeve.

To facilitate assembly of the membrane bundles after potting of fiber membranes, each bundle flange may be assembled from two halves.

The packing density of hollow fiber membranes is selected to optimize passage of vapor away from the permeate side of the hollow fiber membranes towards the shell of the module. Fiber density is expressed as a percentage calculated as: cross-sectional area of fibers in the bundle (based on outside diameter (OD) of the fibers)/total cross-sectional area of bundle×100. In previous designs where fiber membranes were anchored by physical forces it was impossible to use packing densities of lower that 60% because at lower packing densities, the bond between the fibers and the potting was not strong enough to maintain integrity in use, allowing liquid to leak to the permeate/vapour side of the membrane and causing the bundle to fail. By using chemical bonding forces to hold membrane fibers it is possible to make membrane bundles with lower fiber densities. To provide sufficient vapor space between fibers to evacuate the produced vapor with less resistance, the packing density of hollow fiber membranes in the bundle is less than 60%, preferably 50% or less, more preferably in the range from 40% to 30%, or in the range from 30% to 20%. Bundles with packing densities in the range from 40% to 30% produced permeate fluxes 10 times higher than previous design.

The center core is a longitudinally disposed tube for conducting feed water from a feed water inlet of the bottom cap to the opposite (top) end of the membrane bundle. Feed water flows upward through the center core until it reaches the top cap which distributes the water in a downward flow through the hollow fiber membranes. The bottom cap may therefore include both a feed water inlet and a concentrate water outlet plus a leakage discharge outlet. Alternatively, the module may be configured so that feed water enters the hollow fiber membranes from the bottom flows upward through the fibers and concentrate is returned to the bottom of the module via the center core.

An end core communicates with the center core and connects the membrane bundle with the bottom cap. The end core seals between the feed side and vapor side via O-rings.

At least one of the top cap and the bottom cap is adapted to allow it to be released from the vessel body to permit removal and replacement of the membrane bundle. Preferably, both the top cap and the bottom cap are adapted to allow them to be released from the vessel body to permit removal and replacement of the membrane bundle.

The capability to remove the fibers confers the following advantages to the module:
It saves money in the overall economy of the project as at the time of bundle replacement the membrane housing, top cap and bottom cap are kept. In this new design, only the bundle is changed.
The fiber bundle can be dried in a separate drying chamber if the hydrophobic membranes become wet.
The fiber bundle can be replaced in the event that they are chemically or mechanically damaged.
The fiber bundle can be replaced as more efficient fiber technologies are introduced.
The fiber bundle can be replaced to suit customized application configurations.

Membrane Module Volume: The free membrane module volume is volume of the membrane housing minus the volume occupied by membrane bundle components including the volume of membrane fibers based on the outside diameter (OD) of the fibers. This is the available space for the produced vapor. This space is sized and distributed so as to a) produce enough space between fibers to let the produced vapor to traverse between fibers towards the shell/vapor side with minimum resistance, b) the free membrane module volume must be connected to the vapor collector (also referred to herein as vapor header) and in general should provide a vapor velocity in the range of 50-150 fps within the housing and particularly where leaving the housing although vapor velocity within the fiber bundle should be below speed of sound in the established vacuum. The vapor space requirements for optimal throughput of permeate for a given application/operation are calculated based on known values for the volume of produced vapor per pound of water at different vacuums and temperatures. Considering all these will allow a flux of about 30 l/m²/h with hollow fibers of 1 mm internal diameter. If the free membrane module volume is too small, then the flash effect is impaired. The incomplete flash results in membranes operating at sub-capacity utilization. If the vapor volume is too large, then condensation will form within the vessel and the flash effect will also be impaired.

The size of the vapor outlet is selected to optimize extraction of vapor by the vacuum pump. The cross section of the vapor outlet is calculated to provide a good vapor velocity within the range of expected permeate flux. If the vapor outlet is too small the vapor velocity will go up too much and this will be a resistance towards vapor evacuation Preferably, the velocity of the vapor should fall within the range of 50-150 feet per second (fps). When the membrane module is installed vertically, positioning the vapor outlet at the top of the module is advantageous for optimal exit of vapor from the module and hence for optimal flux through the system. However, if the system is operated in outside-in mode then vapor outlets can be positioned on both sides of the membrane bundle.

The module is designed so that it can be operated with feed water supplied to the inner space (lumen side) of the fibers from the top or from the bottom of the module. Prior art vacuum distillation modules are designed to accept feed flow from the bottom only. The module described herein can accept feed flow from the top which distributes the feed flow evenly within the fibers.

Preferably, the fibers are hydrophobic through the whole fiber structure with no coating materials.

The feed water inlet of the module bottom cap is in fluid connection with the center core which acts as an upflow tube opening into a reservoir in a membrane bundle top cap for supplying feed water to the plurality of hollow fiber membranes.

In an alternative mode of operation, the fiber bundle can be suspended in a feed water tank and the vapor extracted from two ends of the bundle in outside-in operation, meaning that the feed water is on the shell side or outside of fibers and the vapor is collected from lumen side of the fibers.

In a further aspect, the invention provides a process for separating dissolved solids from water, which comprises passing raw feed water through a hollow fiber membrane distillation module as described herein, and recovering purified water from the water vapor extracted through a vapor header outlet. Thus, the module and process of the invention are useful for water desalination.

The module and process also have utility for concentration of salts present in the feedwater.

In the examples described herein, the membrane bundle and module are configured for flow of feed water from the inside of the hollow fiber membranes to the outside and passage of vapor from outside of the hollow fiber membranes is the permeate side, also called inside-out operation.

### BRIEF DESCRIPTION OF THE DRAWINGS

FIG. 1 is a longitudinal cross-section of a membrane distillation module showing module shell, fiber bundle with bundle top cap, and attached bottom module cap.

FIG. 2 is an enlarged view of the bottom part of the cross-section of FIG. 1 showing detail of the attachment of the module bottom cap to the fiber bundle and to the module shell.

FIG. 3 shows section and perspective views of the module bottom cap.

FIG. 4 is an exploded view of the fiber bundle of FIG. 1.

FIG. 5 is a side elevation of a membrane bundle according to an embodiment of the invention.

FIG. 6 is an enlarged view of the top part of the cross-section of FIG. 1 showing detail of the bundle top cap attached to the top end of the fiber bundle.

FIG. 7 shows section and perspective views of the fiber bundle spacer ring.

FIG. 8 is a top view of the fiber bundle of FIG. 1 showing an example fiber packing arrangement.

FIG. 9 is a side elevation of a fiber bundle according to an embodiment of the invention showing the effective membrane length, “L_{E}”.

FIG. 10 is a perspective cut-away of the top end of the module of FIG. 1 showing space between the fibers.

FIG. 11 is a top view of the top end of the module of FIG. 1 showing the vapor escape/evacuation area in black.

FIG. 12 is a longitudinal cross-section showing the membrane distillation module of FIG. 1 and attached vapour header.

FIG. 13 is a graph showing the effect of varying fiber membrane packing density of a membrane bundle on the permeability of the bundle.

### DETAILED DESCRIPTION OF EMBODIMENTS

To the accomplishment of the foregoing and related ends, certain illustrative aspects are described herein in connection with the following description and the annexed drawings. These aspects are indicative of the various ways in which the principles disclosed herein can be practiced. Other advantages and novel features will become apparent from the following detailed description when considered in conjunction with the drawings.

In one embodiment, the removable hollow fiber membrane bundle comprises: hollow fiber membranes with optimized packing density and fiber slack, two membrane boots, one at each end, where fibers are potted and fixed, two removable flanges one at each end, four supporting rods which hold the membrane fibers in position, a center core which is used for feed flow, a center core end that connects the membrane bundle to the bottom cap. The membrane boots contain a potting material that holds the fibers in place and, together with O-rings, provides the required sealing between feed water and permeate side. The potting compound in which the ends of the hollow fiber membranes are fixed, i.e., embedded, may comprise at least two layers of different hardness/rigidity.

In one embodiment, the hollow fiber membranes have a molecular cut-off corresponding to pore sizes between about 0.25 micron and about 0.45 micron.

Each end of the membrane bundle may further comprise a spacer ring.

O-rings provide a watertight seal between the top of the membrane bundle and the top cap and between the bottom end of the membrane bundle and the bottom cap.

The bottom cap is manufactured in one piece. The bottom cap comprises an end core receiver which receives the end core to connect the membrane bundle with bottom cap. The end core receiver is provided with O-rings to provide a watertight seal with the end core. The bottom cap further comprises a feed water camlock connection, a concentrate water camlock connection, a seepage camlock connection and means for connecting the bottom cap with the module shell.

The bottom cap further comprises a seepage outlet allowing any liquid that should pass through the membrane into the vapor zone to be collected and returned to the feed side of the process.

The membrane bundle is connected to the membrane module via its end core and O-rings. The sealing of top and bottom caps is also assisted via spacer rings with a chamfer from one side which compresses O-rings when the caps are secured to the shell by attachment means (e.g., bolts). In an embodiment, the vessel body comprises a bundle top flange for connection to a corresponding flange on the bundle top cap and a bundle bottom flange for connection to a corresponding flange on the bottom cap. The flanges may be manufactured to have the same dimensions and bolt hole pattern as an industry standard flange, for example 8″, 12″, 16″ or other such industry standard flange connection. The connection between respective flanges is accomplished via interconnecting bolts. There is a seal or multiple seals between the flanges such that the bundle top flange provides a vacuum tight seal with the bundle top cap and also provides vapor channels, the gaps between the top flange and the shell which connects the shell to the vapor collector, and the bundle bottom flange provides a vacuum tight seal with the bottom cap. The top or bottom cap may be disconnected from the module by removal of the interconnecting bolts, allowing removal of the fiber bundle for servicing, repair, or replacement.

The module end caps are rigorously engineered to sustain the required vacuum during operation of the module.

Preferably, the raw feed water containing dissolved solids supplied to the feed water inlet is at a temperature in the range of about 50° C. to about 85° C. and there is a temperature drop in the feed water temperature from inlet to outlet in the range of about 5° C. to about 15° C.

This process is capable of separating dissolved solids from water at various salt concentrations, preferably when total dissolved solids (TDS) is above 60,000 ppm. Any soluble substance that is dissolved into water can be removed by the process except materials that could compromise the hydrophobicity of the membrane fibers.

Raw feed water may be supplied to the hollow fiber membranes at a constant hydraulic pressure of less than 10 psi with a maximum water entry pressure (WEP) of 25 psi. The WEP depends on the molecular cut off of the membrane used. Tighter membranes can accept higher WEPs.

The exterior of the hollow fiber membranes may be exposed to a vacuum of about 20-200 mbar.

The hollow fiber packing density of the membrane bundle is engineered for optimal flow of vapor from each of the membrane fibers for a given application.

The ends of the hollow fiber membranes and ends of the central core are chemically bonded to the potting boots. This maintains the integrity of the membrane bundle, resulting in minimal or zero leakage.

Parts Key
Hollow Fiber Distillation Module comprises:

| | |
|---|---|
| membrane element | 2 |
| shell | 4 |
| module top flange | 6 |
| module bottom flange | 8 |
| module bottom cap | 24 |

Membrane Element comprises:

| | |
|---|---|
| membrane bundle | 20 |
| membrane top cap | 22 |

Membrane Bundle comprises:

| | |
|---|---|
| hollow fiber membranes | 200 |
| top membrane boot | 202 |
| bottom membrane boot | 204 |
| potting material | 206 |
| center core | 208 |
| center core end connector | 210 |
| bundle top flange | 212 |
| bundle bottom flange | 214 |
| supporting rods | 216 |
| spacer rings | 218 |
| O-rings | 220 |

Bottom Cap comprises:

| | |
|---|---|
| bottom cap flange | 230 |
| end core receiver | 240 |
| feed water camlock connection | 242 |
| concentrate water camlock connection | 244 |
| seepage camlock connection | 246 |

### Example 1—Vacuum Membrane Distillation Module

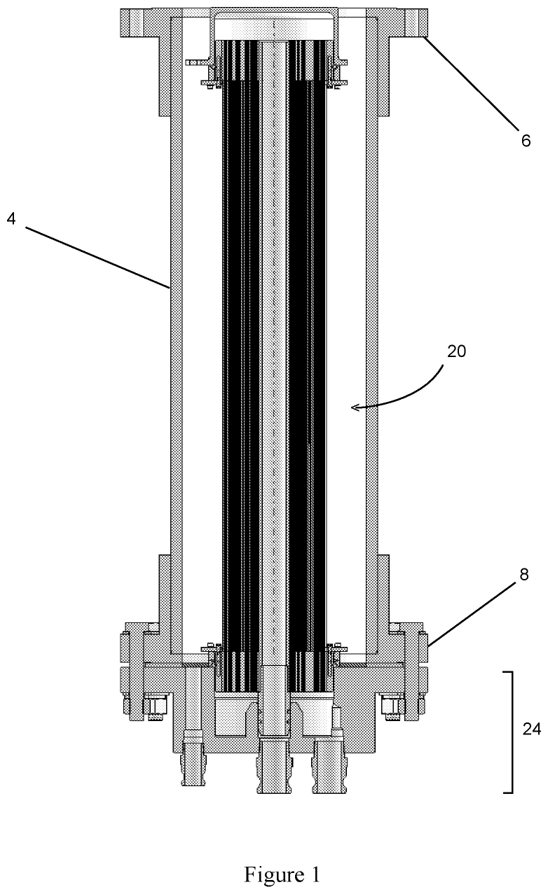

FIG. 1 shows a Hollow Fiber Distillation Module (HFDM) which includes a housing comprising a tubular shell 4 (“vessel body”) having a module top flange 6 and a module bottom flange 8 at top and bottom end, respectively. Each flange is manufactured from an engineered plastic and is connected to the vessel body via a chemical welding, fusing or gluing process.

The shell 4 is a single round tube made of a thermoplastic capable of withstanding operating temperatures varying from 5° C. to 120° C.

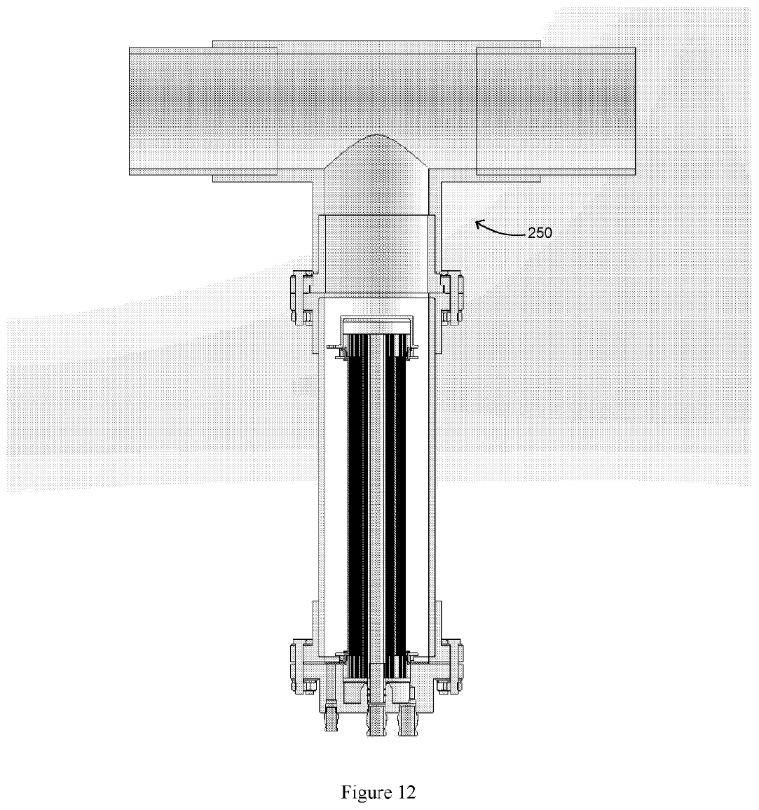

Module top flange 6 provides for connection to a corresponding flange on a vapor collector header (see FIG. 12). The connection between the flanges is accomplished via interconnecting bolts. One or more seals between the flanges provide a seal under vacuum.

In similar fashion, module bottom flange 8 provides for connection to module bottom cap 24. The bottom cap receives membrane bundle 20 and therefore serves as bottom cap of the membrane element.

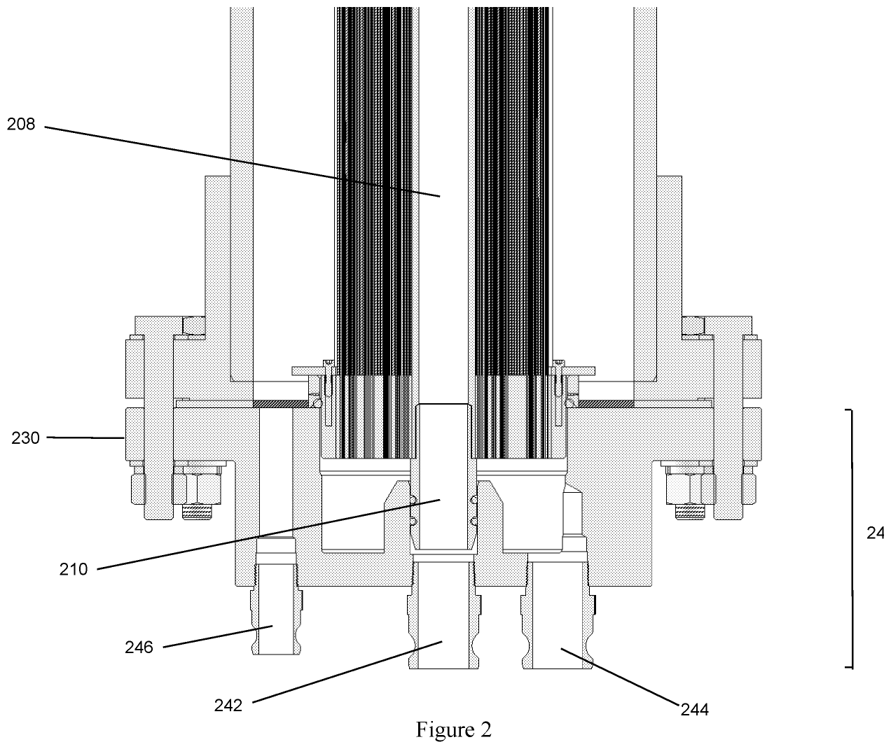

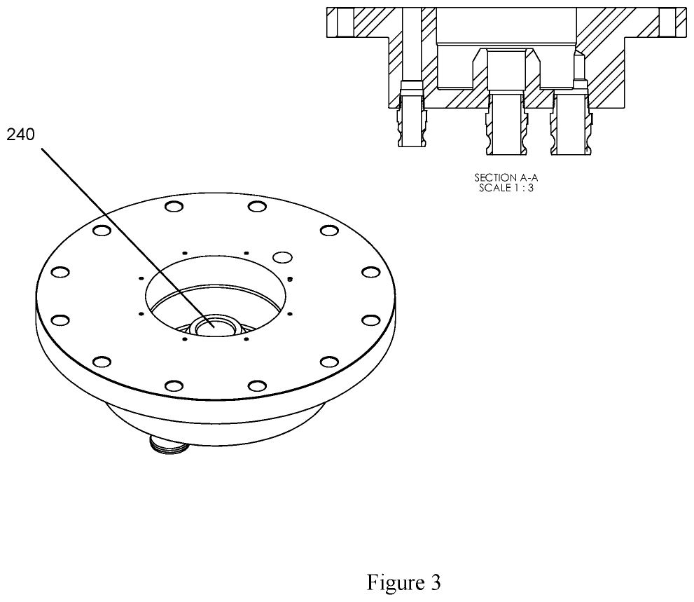

Referring to FIGS. 2 and 3, the bottom cap 24 is manufactured from a single piece of thermoplastic. One end incorporates an industry standard 12″ flange 230 having the same bolt pattern as the module bottom flange 8. The opposing end incorporates the hydraulic connections to the cap including the feed water inlet 242, the concentrate water outlet 244 and a seepage outlet 246. The feed water inlet 242 is fluidly connected to the center core 208 of the fiber bundle.

The feed water inlet 242 is of the standard 2″ male “Camlock” connection type. A series of seals ensures the hydraulic integrity at the interface point of the bottom cap 24 with the center core end 210 of the fiber bundle.

Liquid flowing out of the membrane fibers is collected in the bottom cap 24 and directed to the concentrate outlet 244 of the 2″ male “Camlock” connection type. A series of seals ensures the hydraulic integrity at the interface point of the fiber bundle with the bottom cap 24 and concentrate outlet 244.

The seepage outlet 246 is at the bottom cap of the membrane element. Any liquid that should pass through the membrane is collected and returned to the seepage tank of the process via the seepage outlet 246. The seepage outlet 246 is of the 1″ male “Camlock” connection type.

Male “Camlock” connections for feedwater, concentrate and seepage correspond to female “Camlock” connections which are typically by braided hose or rubber hose but may also be a hard-piped connection.

The bottom cap 24 comprises a receiver for a fiber bundle having an approximate diameter of 8″. The receiver is designed to accommodate complete vacuum. The receiver is at the centre of the bottom cap 24. This receiver is a female connection point for the fiber bundle which is approximately 150 mm dia. Central to the receiver for the fiber bundle is an end core receiver 240 for receiving a center core end connector 210 of the membrane bundle.

The receiver is equipped with two “O” ring seals around its inner circumference. These seals are designed to ensure that vacuum integrity and hydraulic integrity are maintained and that the fiber bundle is securely seated.

A gasket is provided to seal the bottom cap to the bottom shell flange, this is a vacuum seal.

### Example 2—Hollow Fiber Membrane Bundle

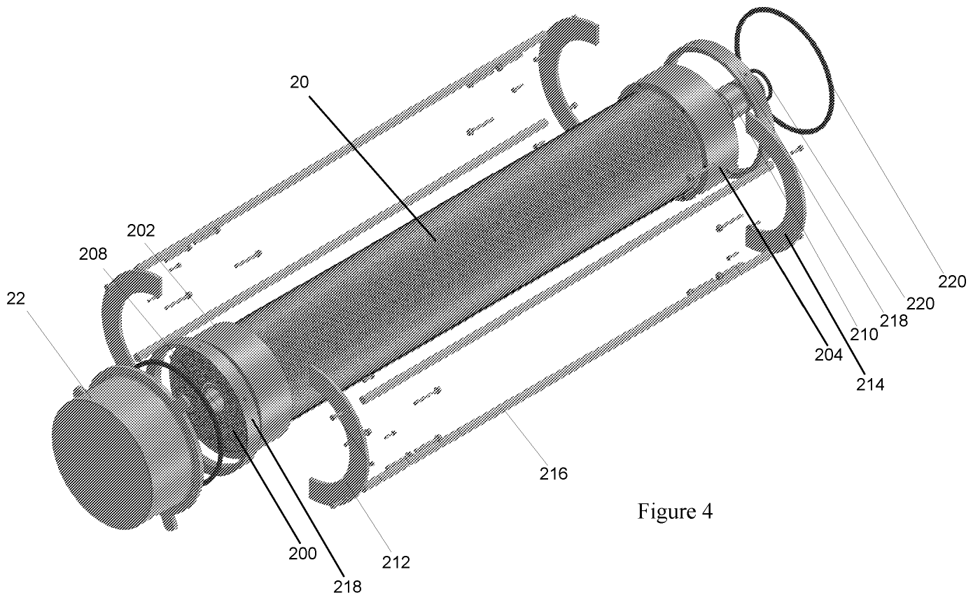

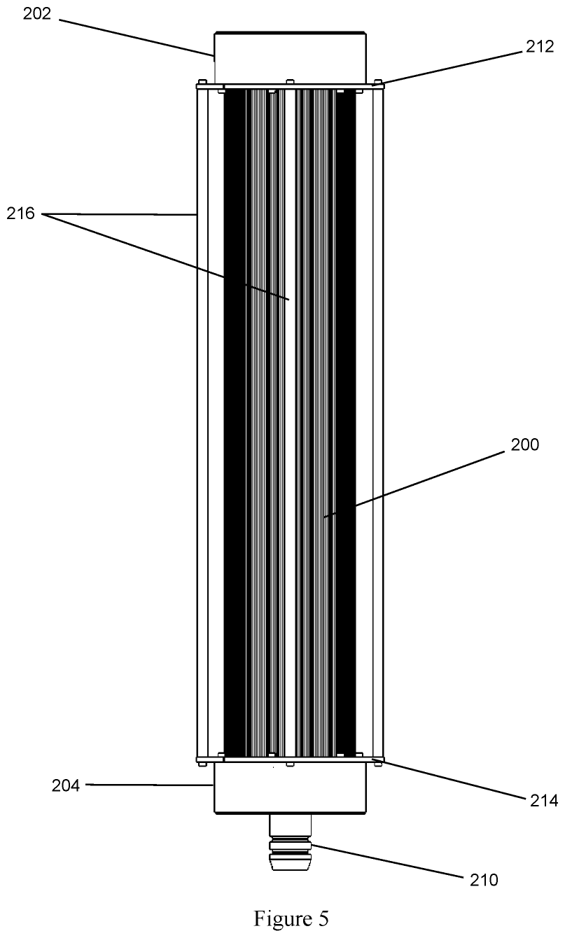

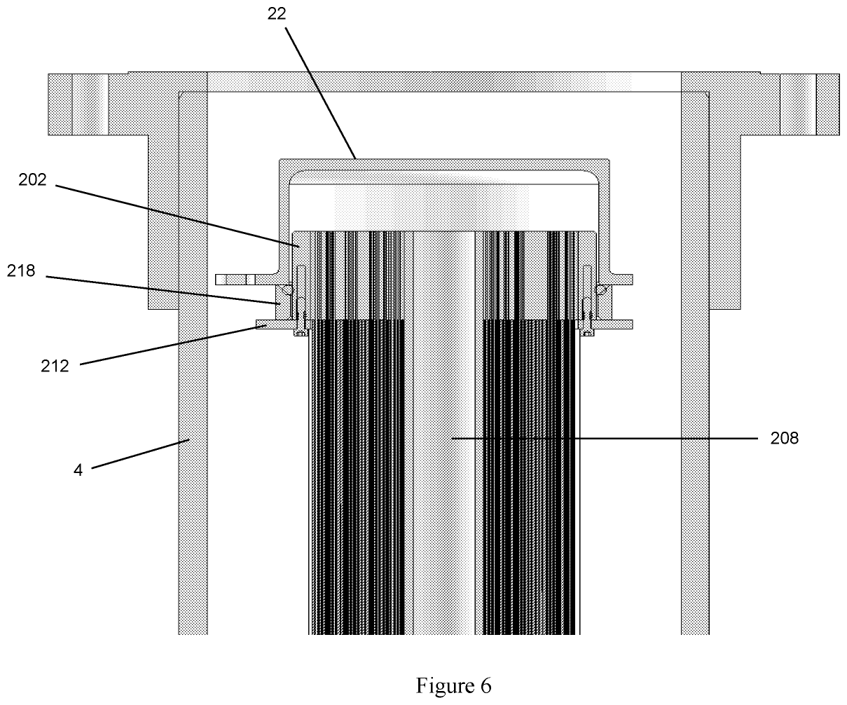

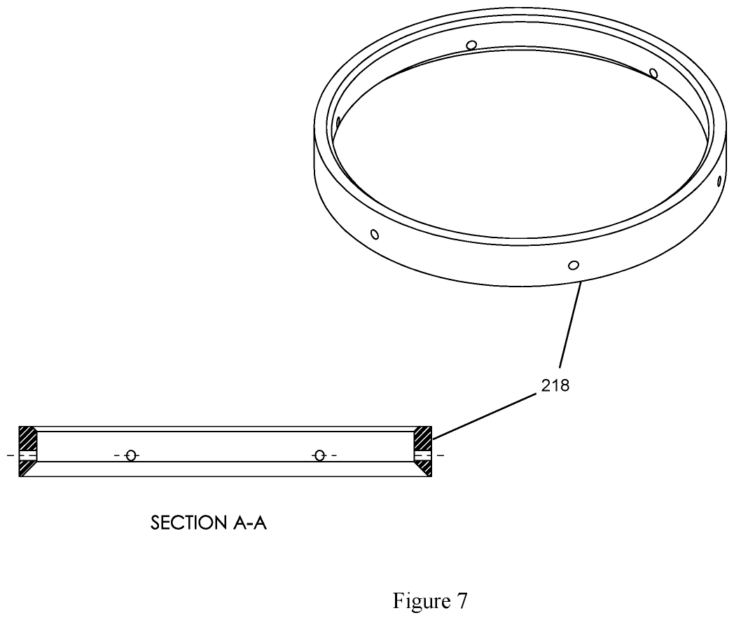

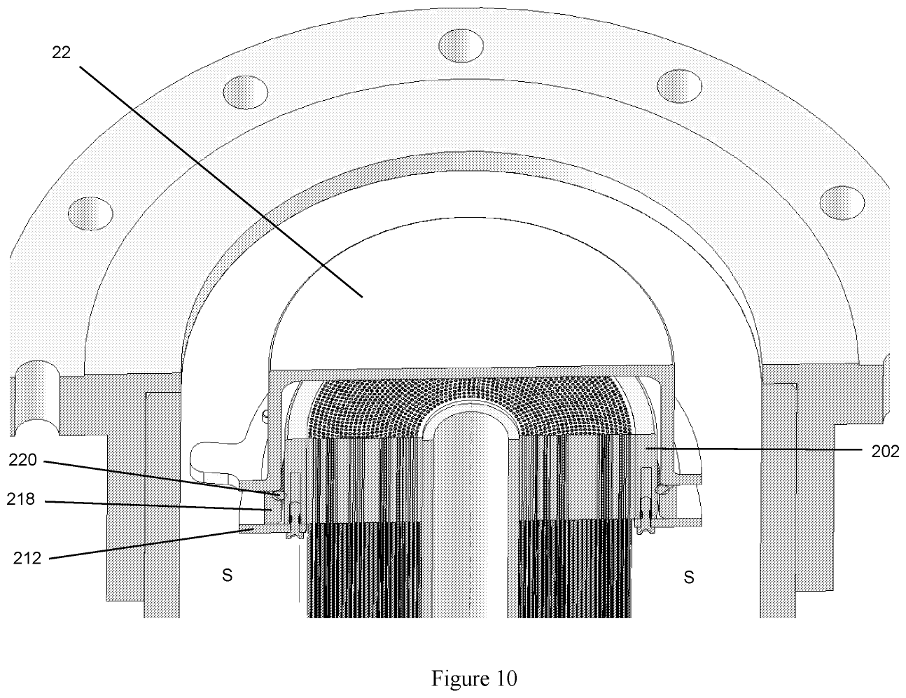

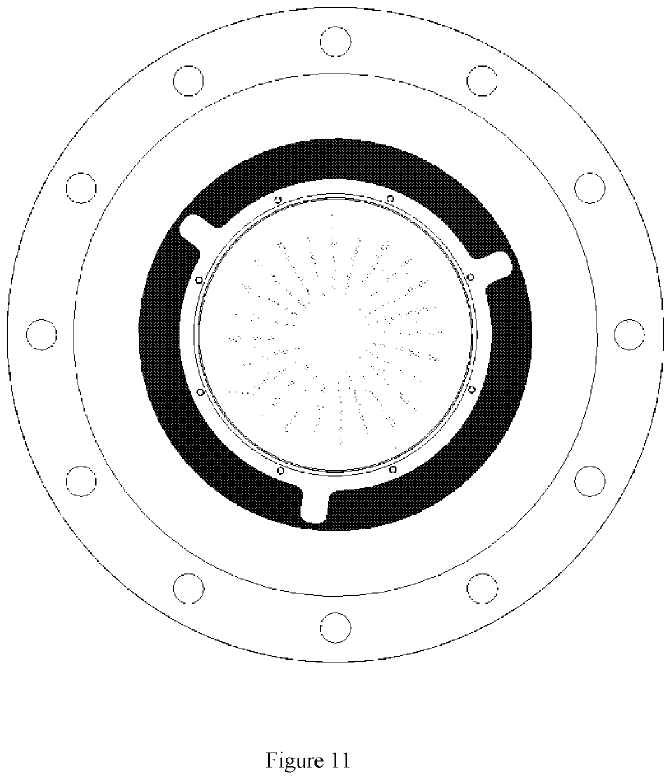

Referring to FIGS. 4 and 5, a bundle 20 of hollow fiber membranes 200 is disposed between top and bottom membrane boots 202, 204. The ends of the hollow fiber membranes 200 are secured to the membrane boots 202, 204 by chemical bonding to a potting compound. Each membrane boot 202, 204 has an attached bundle flange 212, 214. Each of the bundle flanges 212, 214 comprises two halves, for ease of assembly. Supporting rods 216 are secured at each end to the respective bundle flanges and provide structural support to the bundle 20. A center core 208 runs up the center of the fiber bundle 20. A center core connector 210 provides a fluid connection for feed water to enter the center core 208 from the feed water inlet 242 of the bottom cap 24. A top cap 22 is sealingly attached to the top membrane boot 202 as shown in FIG. 6. The center core 208 transmits feed water from the bottom cap inlet 242 to the top cap 24 where it is distributed to the hollow fiber membranes for return flow down the inside (lumen) of the hollow fiber membranes 200. A spacer ring 218, as shown in FIG. 7, disposed between the top membrane flange 212 and the top cap 22 assists with engagement and sealing of the top cap 22, as shown in FIG. 6. The inner surface of the spacer ring is chamfered at one edge to seat an O-ring. Another spacer ring 218 assists engagement and sealing of the bottom membrane boot 204 with the module bottom cap 24, as seen in FIGS. 2 and 4. Projections extending radially from the top cap 22 are dimensioned to approach or abut the inner circumference of the module shell 4, thereby locating and supporting the membrane element in proper axial orientation and protecting the membrane bundle 20 from malfunction or damage resulting from lateral movement within the shell 4 (see e.g., FIGS. 10 and 11).

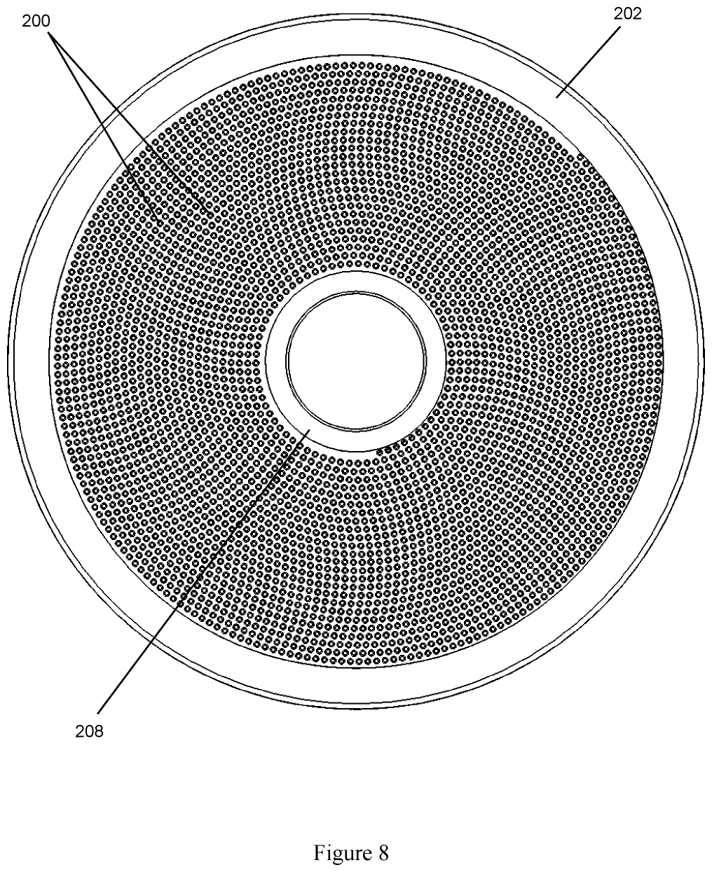

FIG. 8 is top view of a fiber bundle 20 showing an example packing arrangement of hollow fiber membranes 200. The flow of vapor around the membrane fibers is influenced by the packing density of the fibers. The packing density of the membrane bundle is engineered for optimal performance for the intended application. Water vapor passing through the hollow fiber membranes 200 is able to exit the bundle 20 into space S between the outer circumference of the membrane bundle 20 and the inner surface of the module shell 4 and is extracted under vacuum through vapor header 250.

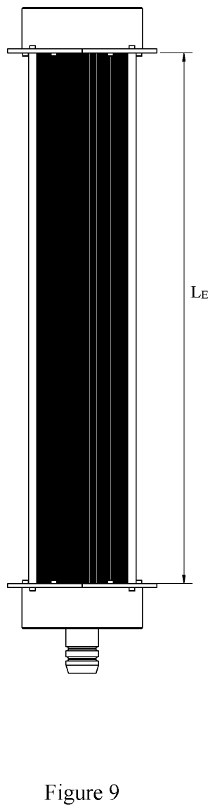

The effective membrane length, L_{E}, is the length of a fiber bundle, between top potting boot 202 and bottom potting boot 204, that contributes to vapor production, as shown in FIG. 9. Total membrane bundle length, L_{T}, refers to the total length of a membrane bundle, including L_{E}, the length of bottom cap 24 including bundle inlet Camlock connector 242, the length of two potting boots 202, 204 and the length of top cap 22.

### Components and Material Science

The membrane bundle and in particular, the membrane potting compound 206, membranes 200 and all wetted components are designed with materials that are capable of withstanding:
Temperatures from 5° C. to 120° C.
pH levels from 1 to 14.
Oxidants.
Near complete vacuum.

### Component Descriptions

As shown in FIG. 11, the Hollow Fiber Membrane Bundle consists of the following main components:
1. Membrane Bundle Top Cap. Top cap feed distributer made from SS316L or other materials comply with the relevant material specification. The top cap 22 is affixed over the “Potting Boot” 202 and is designed to create a seal plus conduct/distribute the feed flow into hollow fibers 200.
2. Potting Boots. The potting boots 202, 204 are affixed to the ends of the “Fiber Bundle” and are made of plastic, PSU (polysulfone), CPVC, other. There are two identical potting boots which are affixed to the top and bottom of the fiber bundle. A potting compound mastic 206 is poured into the caps locking the hollow fiber membranes in place in the “Potting Boots”.
3. Central core made from PSU or CPVC, other. The central core 208 in membrane bundle acts as a feed flow channel.
4. Bundle Top Flange 212 and Bundle Bottom Flange 214 are metal rings made from titanium or SS 316L to hold the membrane bundle support rods 216 connecting the membrane bundle to the bottom and top caps 22, 24. Each flange is comprised of two haves for ease of assembly.
5. Feed entry male connection to the membrane bundle. A water inlet connector of the “Camlock” connection type, developed and governed by U.S Military Specifications is used in this design at the feed water entry point as well as at the bottom membrane module cap.
6. O-rings 220: Used to seal the center core 208 to the bottom caps 24.
7. Dimensions. The membrane bundle has an approximate diameter of 18.54 cm (specific bundle dimensions will be compatible with the latest KMX membrane shell design).
8. Hollow Fiber Membranes. The “Hollow Fiber Membranes” 200 are made of a proprietary hydrophobic material that may be PTFE, Polysulfone or other materials. The specifications of the membrane hollow fibers are detailed in the following description.
   8.1 Designed to withstand continuous operations in a dynamic environment.
   8.2 Designed to withstand breaking at the point where they join the potting compound mastic. This has been known to occur in other designs.
   8.3 The hollow fiber membranes could have a pore size cut-off off between 0.25 and 0.45 micron.

### Process Description

This section describes the process and applications for vacuum membrane distillation of which the membrane bundle provides the primary separation role; and along with the membrane shell are the most important components of technology.
1. Applications. This process is designed to separate dissolved solids from water at various concentrations although typically more efficient when feed TDS is above 60,000 ppm of soluble materials. This can be any soluble substance that is dissolved into water, preferably salts.
2. Raw Water Feed to Membrane Bundle. The raw water containing soluble materials is pumped to the connection point at the “Module Bottom Cap” 242 from which it enters the center core 208 of the membrane bundle. The connection point is a vertical structure with an up-flow tube (central core 208). At the end of the neck of this tube, the membrane bundle opens to a “top cap” 22 which is engineered to distribute the feed water to the individual hollow fibers within the bundle. The bundle consists of between 1,500 and 5,000 fibers which must operate at a relatively constant pressure and constant feed.
3. Feed Temperature. The temperature of the feed water is between 30° C. and 85° C.
4. Pressure Balance. The feedwater pressure inside the membrane fibers (typically <10 psi) is sufficient only to circulate the water through the membranes. The exterior of the membrane fibers is exposed to vacuum. The “driving force” through the wall of the membrane fiber is a combination of feed pressure (about 10 psi) and vacuum pressure. This is about 24 psi at maximum for the current membrane.
5. Phase Transfer Mechanism. The transition from liquid phase on the interior of the individual hollow fibers to vapor phase on the outside the individual fibers takes place at the interface between liquid at the vicinity of internal membrane wall of the membrane causing “flashing” induced by the pressure gradient across the two sides of the membrane wall and forcing the produced vapor out of the membrane pores towards the outside of hollow fibers. Since the inner walls of the membranes are hydrophobic, the passage of liquid across the membrane fiber is prevented and only vapor can pass.
6. Phase Transfer Mechanism via Flash Distillation. The induced vacuum on the outside wall of the membrane fibers creates a condition where the warm feed vapor pressure is greater than the low-pressure environment induced by vacuum which causes a flashing (boiling) to occur. The continuous flash effect causes a temperature drop alongside the membrane fibers while the feed water flowing through the fibers as the energy is transferred to the vapor. The vapor, on the shell side of the membrane bundle is collected from the module shell and condensed into pure water in a separate process as water is removed from the feed (as vapor), the total dissolved solid (TDS) concentration of the feed water increases. The process could continue to the point of crystallization of dissolved solids in the feed. The dissolved solids are removed and disposed of or sold for use in other processes.

### Example 3—Impact of Packing Density on Permeability

Flux is the volume of permeate generated per unit area of membrane per unit time and may be expressed as l/m²/h, or LMH. The ratio of the flux to pressure is referred to as the permeability.

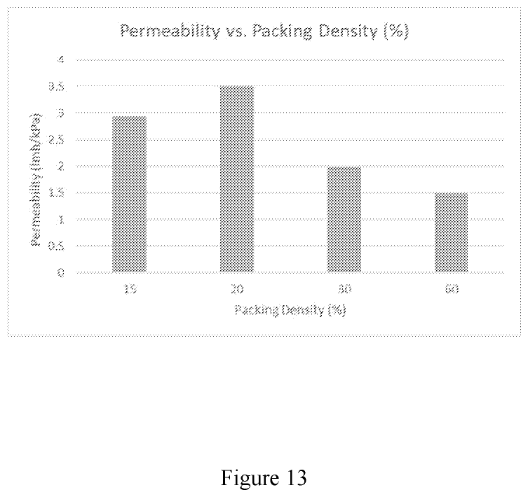

Packing density is defined as the cross-sectional area of the fiber divided by the cross-sectional area of the bundle. Different packing densities were tested in a bench scale vacuum membrane distillation system. A reference bundle with a packing density of 60% was modified to reduce the fiber packing density sequentially to 30%, 20% and 15%. As shown in FIG. 13, an increase in permeability of the membrane bundle, measured as lmh/kPa, was observed when the packing density was reduced below 60%. In this experiment, maximum permeability was observed at a packing density of 20%. The results demonstrate that packing density is a parameter which should be considered when seeking to optimize flux in a module for membrane distillation.

Hypothetically, the packing density represents a resistance to the vapor as it leaves the membrane bundle and progresses to the module shell before exiting though the header.

In subsequent tests, the inventors routinely achieved permeate fluxes of 10-15 l/m²/hour with modules according to the invention.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations. Furthermore, to the extent that the term “includes” is used in either the detailed description or the claims, such term is intended to be inclusive in a manner similar to the term “comprising” as “comprising” is interpreted when employed as a transitional word in a claim.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A hollow fiber membrane distillation module comprising a hollow fiber membrane bundle and a housing for containing the membrane bundle, wherein:
the membrane bundle comprises a plurality of hydrophobic hollow fiber membranes having a first end and a second end, the first end and the second end being secured in a first membrane boot and a second membrane boot, respectively, by chemical bonding of the fiber membrane to a potting compound;
the membrane bundle is supported by a plurality of supporting rods;
each of the first membrane boot and the second membrane boot has an attached flange to which respective ends of the supporting rods are secured, thereby spacing the first membrane boot from the second membrane boot such that the hydrophobic hollow fiber membranes are disposed longitudinally therebetween;
the hydrophobic hollow fiber membranes are packed at a density selected to optimize passage of vapor away from a permeate side of the hydrophobic hollow fiber membranes towards the housing;
the membrane bundle is not enclosed in a porous or perforated sleeve;
a center core spans the length of the membrane bundle;
the housing comprises a tubular body and a bottom cap, is connected to a vapor header, and is configured to optimise throughput of permeate by accommodating expansion of liquid water to the vapor phase during vacuum membrane distillation and to facilitate exit of water vapor from the module via an outlet of the vapor header, said outlet connected to a vacuum pump.

2. The hollow fiber membrane distillation module of claim 1, wherein the potting compound is an epoxy compound.

3. The hollow fiber membrane distillation module of claim 1, wherein the potting compound is chemically bonded to the hydrophobic hollow fiber membranes, the center core, and the membrane boots.

4. The hollow fiber membrane distillation module of claim 1, wherein the fiber packing density is 60% or less.

5. The hollow fiber membrane distillation module of claim 1, wherein the fiber packing density is in the range of 30% to 40%.

6. The hollow fiber membrane distillation module of claim 1, wherein the fiber packing density is in the range of 20% to 30%.

7. The hollow fiber membrane distillation module of claim 1, which is configured to operate a vapor velocity through the housing and vapor outlet of between 50 and 150 fps.

8. A process for separating dissolved solids from water which comprises a step of vacuum membrane distillation in a module according to claim 1.
